(19) United States
(12) Patent Application Publication
(10) Pub. No.: US 2023/0368687 A1
(43) Pub. Date: Nov. 16, 2023

(54) Systems and Methods for Assessment of Phonological Awareness

(71) Applicants: RANDALL SCKAAL, East Kingston, NH (US); CHRISTINA MARIE CASSANO, Salem, MA (US); KATHLEEN A. PACIGA, Chicago, IL (US)

(72) Inventors: RANDALL SCKAAL, East Kingston, NH (US); CHRISTINA MARIE CASSANO, Salem, MA (US); KATHLEEN A. PACIGA, Chicago, IL (US)

(21) Appl. No.: 18/315,608

(22) Filed: May 11, 2023

Related U.S. Application Data
(60) Provisional application No. 63/341,745, filed on May 13, 2022.

(51) Int. Cl. G09B 5/02; G09B 7/06; G09B 19/04

(52) U.S. Cl. CPC G09B 5/02; G09B 7/06; G09B 19/04

(57) ABSTRACT

In an approach to assessment of phonological awareness, one or more images are displayed on a Graphical User Interface (GUI), wherein the one or more images represent one or more words; a response is received from a subject as to whether the subject knows the specific word for each of the one or more images; responsive to the subject knows the specific word for any of the one or more images, the specific word is added to a list of known words for the subject; one or more known item images are displayed on the GUI, wherein the one or more known item images are based on the list of known words for the subject; a picture of phonological awareness is determined that is disentangled from word familiarity based on the one or more known item images.

### CROSS-REFERENCE TO RELATED APPLICATIONS

The present application claims the benefit of the filing date of U.S. Provisional Application Ser. No. 63/341,745, filed May 13, 2022, the entire teachings of which application is hereby incorporated herein by reference.

### TECHNICAL FIELD

The present application relates generally to literacy skills and, more particularly, to systems and methods for assessment of phonological awareness.

### BACKGROUND

Phonological awareness (PA) is among the earliest and most essential early literacy skills. Assessment and monitoring of PA as it develops in emergent and early readers is a key component of the Science of Reading (SoR). Data from PA assessments drive instruction in preschools in US contexts, but the assessments may not accurately capture this skill for DLLs because of the cognitive and task-related demands that exist in commonly employed PA assessment tools. The Individualized Phonological Awareness Test (I-PAT), ensures preschoolers, particularly preschoolers who are Dual Language Learners (DLLs), are familiar with the words on the assessment, thus ensuring the performance is related to PA and not vocabulary knowledge. An assessor shows images of words (e.g., ball) and asks, “Do you know this word?” as a screening measure before the PA tasks are initiated. Then, the PA task items are populated with words known by the child to provide a picture of PA that is disentangled from word familiarity. The test may provide assessment results for teachers and parents that include recommendations for practice and instruction.

### BRIEF DESCRIPTION OF THE DRAWINGS

Reference should be made to the following detailed description which should be read in conjunction with the following figures, wherein like numerals represent like parts.

FIG. 1 is a table providing an overview of one embodiment of a system and method consistent with the present disclosure.

FIGS. 2A and 2B is a table providing a diagnostic assessment for one embodiment of the system and method of FIG. 1 consistent with the present disclosure.

FIG. 3 is an example question for the system and method of FIG. 1 consistent with the present disclosure.

FIG. 4 is an example syllable blending question for the system and method of FIG. 1 consistent with the present disclosure.

FIG. 5 is an example of questions with corrective feedback for the system and method of FIG. 1 consistent with the present disclosure.

FIG. 6 is an example question with initial sound matching for the system and method of FIG. 1 consistent with the present disclosure.

FIG. 7 is an example question with phoneme blending for the system and method of FIG. 1 consistent with the present disclosure.

FIG. 8 is an additional example question with phoneme blending for the system and method of FIG. 1 consistent with the present disclosure.

FIG. 9 is an example question with phoneme segmentation for the system and method of FIG. 1 consistent with the present disclosure.

FIG. 10 is an example question with writing for sounds for the system and method of FIG. 1 consistent with the present disclosure.

FIG. 11 is another example question with writing for sounds for the system and method of FIG. 1 consistent with the present disclosure.

FIG. 12 is an example of a secure login screen for the Graphical User Interface (GUI) of an embodiment of the system and method of FIG. 1 consistent with the present disclosure.

FIG. 13 is an example of a subject data entry screen for the GUI of an embodiment of the system and method of FIG. 1 consistent with the present disclosure.

FIG. 14 is an example of a vocabulary assessment screen for the GUI of an embodiment of the system and method of FIG. 1 consistent with the present disclosure.

FIG. 15 is an example of a multiple image assessment screen for the GUI of an embodiment of the system and method of FIG. 1 consistent with the present disclosure.

FIG. 16 is another example of a multiple image assessment screen for the GUI of an embodiment of the system and method of FIG. 1 consistent with the present disclosure.

FIG. 17 is an example of a single image assessment screen for the GUI of an embodiment of the system and method of FIG. 1 consistent with the present disclosure.

FIG. 18 is an example of a completion screen for the GUI of an embodiment of the system and method of FIG. 1 consistent with the present disclosure.

FIG. 19 is an example of an administrative home screen for the GUI of an embodiment of the system and method of FIG. 1 consistent with the present disclosure.

FIG. 20 is an example of an administrative image library screen for the GUI of an embodiment of the system and method of FIG. 1 consistent with the present disclosure.

FIG. 21 is an example of an administrative image management screen for the GUI of an embodiment of the system and method of FIG. 1 consistent with the present disclosure.

FIG. 22 is an example of an administrative classroom report selection screen for the GUI of an embodiment of the system and method of FIG. 1 consistent with the present disclosure.

FIG. 23 is an example of an administrative student overall assessment report screen for the GUI of an embodiment of the system and method of FIG. 1 consistent with the present disclosure.

FIG. 24 is an example of an application database of word examples for the system and method of FIG. 1 consistent with the present disclosure.

FIG. 25 is a functional block diagram illustrating a distributed data processing environment consistent with the present disclosure.

FIG. 26 is a block diagram depicting components of one example of the computing device suitable for the program, within the distributed data processing environment of FIG. 25, consistent with the present disclosure.

### DETAILED DESCRIPTION

The present disclosure is not limited in its application to the details of construction and the arrangement of components set forth in the following description or illustrated in the drawings. The examples described herein may be capable of other embodiments and of being practiced or being carried out in various ways. Also, it may be appreciated that the phraseology and terminology used herein is for the purpose of description and should not be regarded as limiting as such may be understood by one of skill in the art. Throughout the present description, like reference characters may indicate like structure throughout the several views, and such structure need not be separately discussed. Furthermore, any particular feature(s) of a particular exemplary embodiment may be equally applied to any other exemplary embodiment(s) of this specification as suitable. In other words, features between the various exemplary embodiments described herein are interchangeable, and not exclusive.

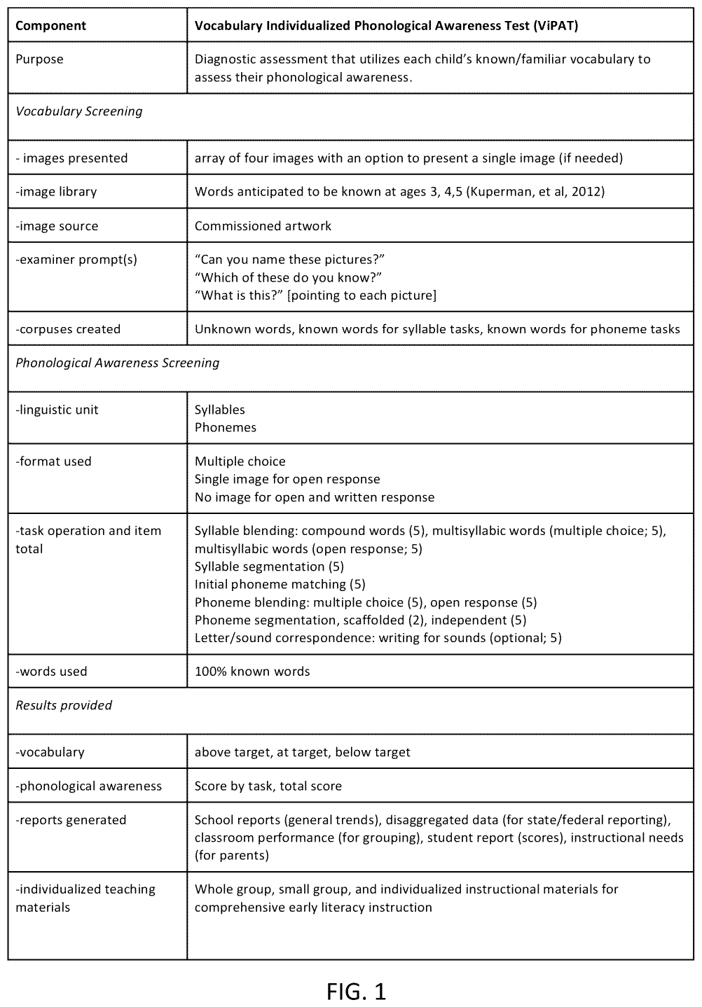

FIG. 1 is a table providing an overview of one embodiment of a system and method consistent with the present disclosure. In some embodiments, the Vocabulary Individualized Phonological Awareness Test (ViPAT) may be a web-based application, henceforth referred to as an “app,” designed to function as a literacy assessment and curriculum instrument. The ViPAT may serve three critical functions (1) identify children who may be at-risk for reading difficulties due to below-target PA and oral vocabulary (OV) performance; (2) provide support for differentiated instruction based on child- or class-specific needs; and (3) document progress in PA and OV.

The intended users of the ViPAT may be validated for use with monolingual and multilingual preschool and kindergarten-aged children (e.g., 3- to 6-year-olds). It may also be useful for older, struggling readers who are experiencing difficulties with PA and/or vocabulary.

The ViPAT is administered individually in an environment conducive to early childhood assessment. The ViPAT can be pre-loaded with the child's name, date of birth, and language(s). The assessor initiates the vocabulary screening by selecting a child's profile and clicking start. During the vocabulary screen, the child views a series of images on a shared computer screen. The images presented are color line images created for this assessment and based on age-of-acquisition data. That is, 3-year-olds may be presented with images of words typically learned by age three, 4-year-olds may be presented with images typically learned by age four, etc. Images can be presented as sets of four or individually based on the child's specific needs. All images identified accurately are recorded as “known words” and included in the child's familiar word bank. At the conclusion of the vocabulary screen, the PA assessments populates with known images only. This approach ensures that incorrect answers are not related to the use of an unfamiliar word (e.g., cub versus bear). Consistent with the research on PA, the assessment progresses from larger (syllable) to smaller (phoneme) units using tasks critical for decoding (i.e., segmenting and blending). The final task is a writing for sounds task during which the child's letter/sound knowledge is examined. Ten items may be provided for each of the subtests.

Unlike standardized assessments that require teachers to translate standardized results to individualized instructional goals to differentiated instruction, the ViPAT provides child-specific information and recommended materials and instructional strategies to support targeted educational outcomes. Examples include a bank of familiar/unfamiliar words, teaching strategies to build on strengths and support growth in PA, and options to generate individualized decodable texts with familiar images as illustrations and opportunities for authentic writing. Support for differentiated small group instruction and recommendations for whole group instruction can also be provided by selecting groups of children and instructional criteria. For example, a teacher may identify groups of words to highlight during classroom read alouds by selecting words/images that were unfamiliar to 50%, 80% or 100% of the children or by identifying children who could successfully blend phonemes into words but who require additional support with segmenting them.

The app is created to align with hardware commonly available in early childhood education contexts. The ViPAT may function on Internet-connected desktops, laptops, or larger screened mobile devices (children need to see four images simultaneously, in a row or 2×2 grid, to complete the assessment process). Curriculum materials also require a printer or method for sharing the digital files with children (e.g., projector and screen for large group instruction).

The ViPAT data may be stored in a secure, fully encrypted database system using Advanced Encryption Standard with a 256-bit encryption key (AES-256) for PII protection. In some embodiments, the app is developed using JavaScript and PHP to be available initially as a web browser-based tool.

Example educational outcomes (vocabulary) may include that the results offer a general description of vocabulary knowledge (e.g., at-target, below target, above target) based on the number of known and unknown words a child encountered during the vocabulary screen. Because this is a screening tool and not a comprehensive vocabulary assessment, below-target indicates a more fine-grained, diagnostic vocabulary assessment should be used and/or the child should be assessed in their native language. In addition, a list of words that are familiar and unfamiliar to each child as classroom trends may be available. Research-based recommendations for building vocabulary knowledge as well as image cards to supplement instruction (e.g., vocabulary games) may be available.

Example educational outcomes (PA) may include specific performance on syllable- and phoneme-level tasks including the number of items correct for each task may provide insight into what skills the child has acquired, is beginning to acquire, or has not yet acquired. Research-based recommendations for building PA may be provided including individualized decodable texts that include familiar images and writing-for-sound and other authentic reading and writing activities to support development in letter/sound correspondence and decoding.

As a teacher example, Josie is a preschool teacher who is newly trained in the ViPAT. She may administer the assessment with her class of 4- and 5-year-olds. She began the assessment by asking each child to “show me the pictures you know.” During the PA assessment, she proceeded from one task to the next, carefully using the two practice items to ensure the child understood the directions before starting the task and using the prompts and guidance at the bottom of the computer screen. After the administration is complete, Josie reflects on the results. She begins by examining the data from the vocabulary screen. First, she examines the total scores generating a list of children who were “below target” to bring to her child study team noting who she believes should be tested in Spanish, their native language, to provide a more accurate assessment, and which ones require diagnostic testing.

She then examines the classroom trends in word familiarity and makes a note considering how she might “tuck in” some additional vocabulary into her upcoming read alouds. She prints a list of the words unknown to at least half of her class for reference. Next, she examines the results of the PA assessments, dividing children into small groups based on their performance on the syllable-level and phoneme-level tasks. She is pleased to learn that many of the children successfully blended multi-syllabic words, something that she has been working on and noted that some children blended phonemes successfully. She reviewed the recommendations for teaching phoneme blending and remembered the importance of using known words when supporting PA. She downloads two sets of colored images to her tablet--multisyllabic words and consonant-vowel-consonant (CVC) words. She makes a note to use the first set of images with her syllable-focused groups and the other with the group developing phoneme-level awareness.

Most assessment tools for Pre-K are done with printed kits and cannot interact with the child based upon the responses. The majority begin for children in early elementary school (K-3) learning with a small number aimed for younger children. The disclosed app focuses on early learning and the PreK to Kindergarten child. Therefore, the disclosed app is unique in the marketplace. An additional advantage for the disclosed app is the tangible results and options to specifically gear and provide teaching tools to the student(s). Once a teacher has assessed the child, they can access the results of their phonological skills and level of vocabulary development. The disclosed app may then provide a guide of unknown words that the child identified. This guide may provide the next level of teaching and focus for that child to further develop their language skills. A final guide for the class is a feature and valuable tool for the teacher to assess their students. The results may provide a class guide that may focus on the majority of unknown words for class instruction. The disclosed app may deliver a guide within the classroom for instructional suggestions and provide within the guide best practice suggestions to enhance the learning and development of the class.

The teacher may also return after they have taught the student(s) for another assessment. Once the teacher logs in, they are able to select the student and begin a new assessment using the already defined known and unknown words. This may not only save time for the assessment but provide additional insight to the student's learning skills. These additional assessments may occur as needed during the school year. The disclosed app may also give the school the ability to archive the assessments, so when the student(s) return for the next school year, they may call up that student's history and start the year at the level last assessed.

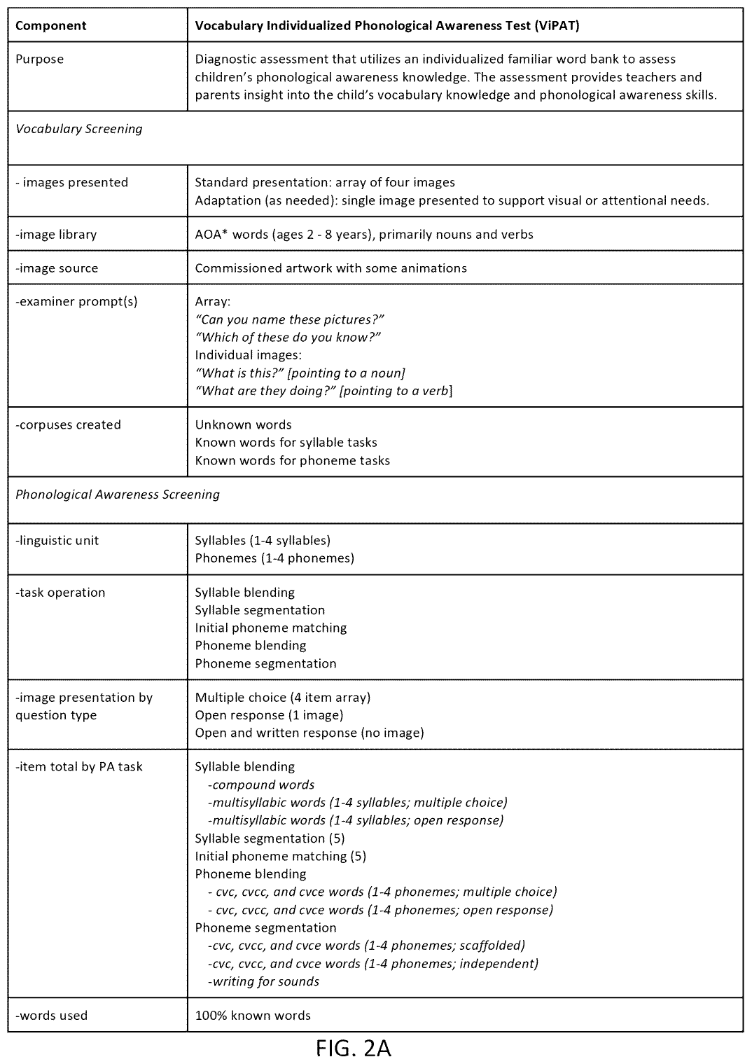

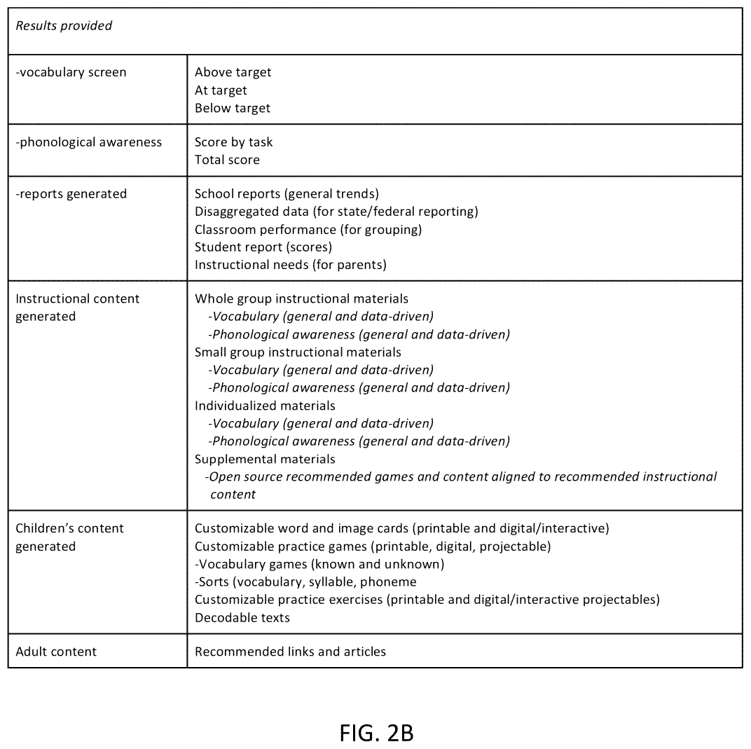

FIGS. 2A and 2B are a table providing a diagnostic assessment for one embodiment of the system and method of FIG. 1 consistent with the present disclosure. In the table of FIGS. 2A and 2B, age-of-acquisition (AOA) is the approximate time a word is learned. AOA word banks may be used to identify vocabulary for the screening (e.g., AOA words for age three may populate the assessment for 3-year-olds, etc.).

Next is the vocabulary screening task. The format/purpose of this task is that the child may be presented with a series of images to name. The images may be presented four at a time, to allow the assessment to progress quickly. Images may vary between four across and a 4-square to support interest and engagement. A corpus of compound words, multisyllabic words, and CVC words are required to populate both the syllabic and sub-syllabic tasks.

Selected images may be based on AOA or the approximate age at which a word is learned. The child's chronological age may determine the AOA of the images presented. For example, three-year-olds may begin with images with an AOA of age three. Scoring may be performed by the assessor clicking on the images named correctly and then advance to the next screen.

Modifications may include that the assessor has the option to present one image at a time to support the administration of the assessment (e.g., the child appears distracted or confused by the presentation of multiple images).

Results may include (1) correctly identified images may then populate the subsequent assessment tasks, i.e., only familiar words are used on the assessment; and (2) based on the chronological age of the child and the vocabulary screening results, a rating of above target, at target, or below target may be reported. Below target indicates a diagnostic vocabulary assessment (e.g., Peabody Picture Vocabulary Test) may be required, or, if the child is a dual language learner, the assessor should consider assessing the child in both languages.

Progress monitoring assessments include familiar and unfamiliar images that may be stored for each child. Subsequent assessments may begin with words coded as unfamiliar to document vocabulary growth from Time 1 to Time 2. Additional images may also be presented based on current age.

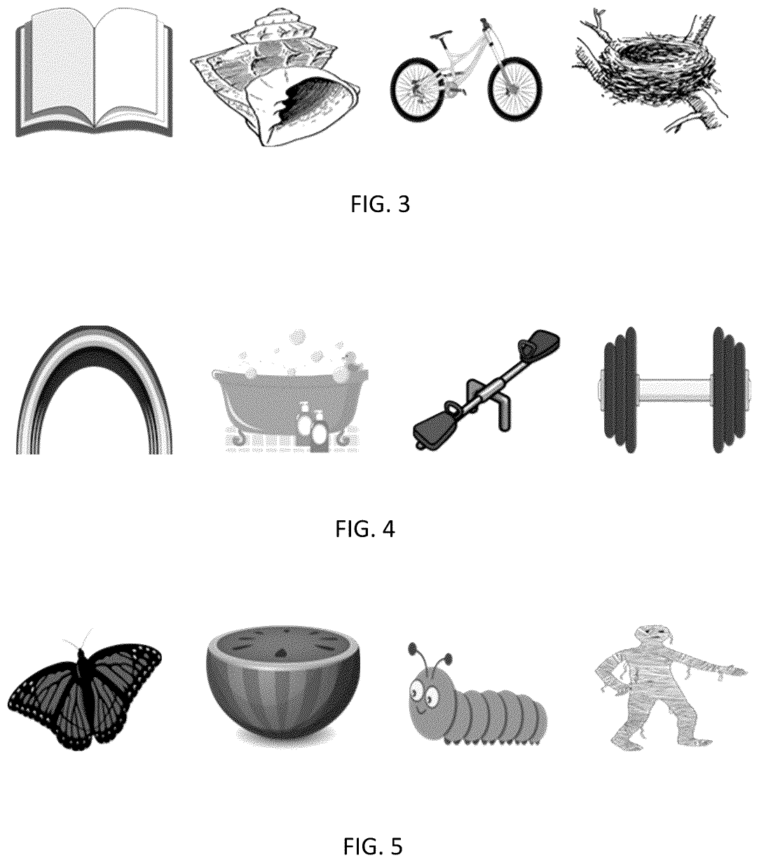

FIG. 3 is an example question for the system and method of FIG. 1. For example: “Can you name any of these pictures?” or “What is this?” [point to each picture]. Part 1 of this section includes syllables/words. FIG. 4 is an example syllable blending with compounds words question for the system and method of FIG. 1. The example of FIG. 4 includes syllable blending (compounds words), where the format is multiple choice/pointing. The practice items include two practice items with corrective feedback, with an item total of five. An example may be “show me rain---bow together?”

FIG. 5 is an example of questions with multisyllabic words with corrective feedback for the system and method of FIG. 1. The first example question of FIG. 5 includes syllable blending (multisyllabic words), where the format is multiple choice/pointing. The practice items include two practice items with corrective feedback, with an item total of five. A multiple choice/pointing example may be “show me cat--er--pil--lar together?”

The next example question of FIG. 5 also includes syllable blending (multisyllabic words), where the format is open response. The practice items include two practice items with corrective feedback, with an item total of five. Example: Show me rain---bow together? An open response example may be assessor turns the computer away from the child's line of sight. It may display a multisyllabic word the child knows. The teacher may say, “Put the sounds together. What is cat--er--pil--lar?”

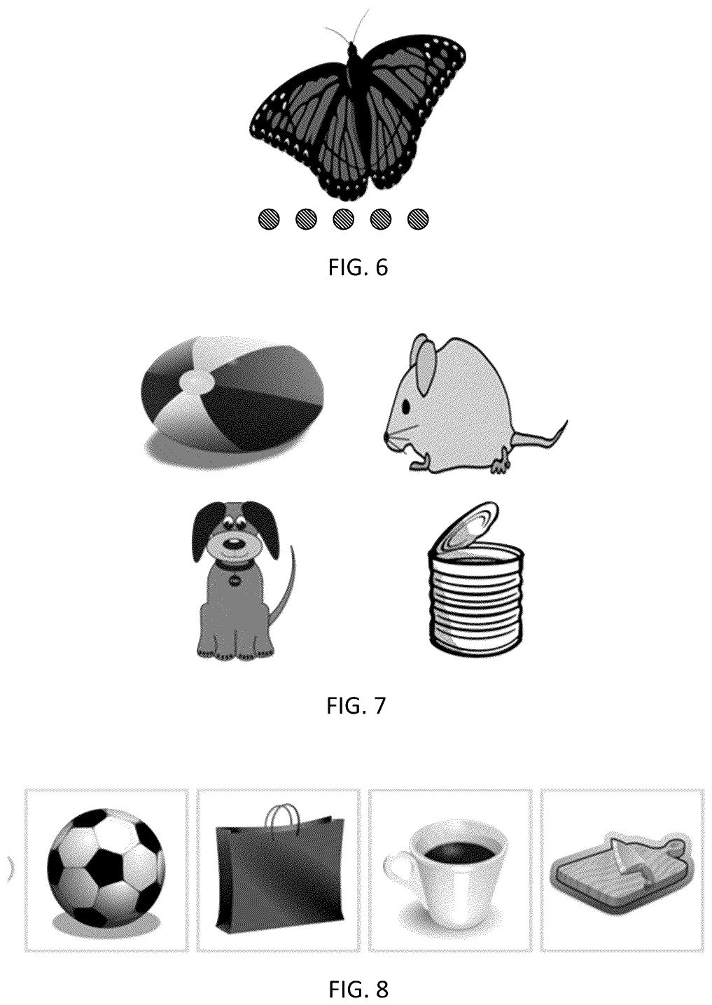

The next section is phonemes. FIG. 6 is an example question with initial sound matching for the system and method of FIG. 1. The example of FIG. 6 includes syllable segmentation, where the format is verbal response [single picture presented to reduce memory demands]. The practice items include three practice items with corrective feedback, with an item total of five. An example may be “what are the syllables in butterfly? [tap the sounds].”

FIG. 7 is an example question with phoneme blending for the system and method of FIG. 1 consistent with the present disclosure. The example of FIG. 7 includes initial sound matching, where the format is multiple choice/nonverbal/pointing. The practice items include two practice items with corrective feedback, with an item total of ten. An example may be “point to the picture that begins with the sound /m/.”

FIG. 8 is an additional example question with phoneme blending for the system and method of FIG. 1 consistent with the present disclosure. The example of FIG. 8 includes phoneme blending I, where the format is multiple choice/nonverbal/pointing. The practice items include two practice items with corrective feedback, with an item total of five. An example may be “point to the picture that is b--a--g together [--indicates a 1-second pause].”

The example of FIG. 8 also includes phoneme blending II, where the format is open response. The practice items include two practice items with corrective feedback, with an item total of five. An example may be “what is d--o--g together? [-- indicates a 1 second pause].”

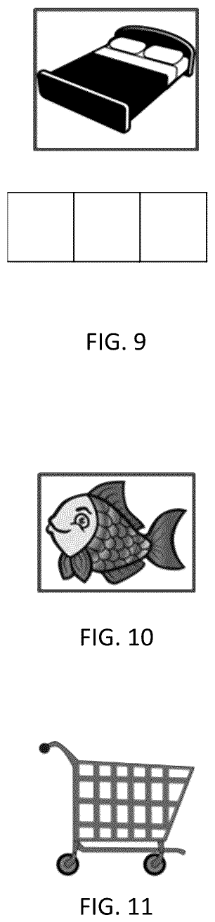

FIG. 9 is an example question with phoneme segmentation for the system and method of FIG. 1 consistent with the present disclosure. The example of FIG. 9 includes phoneme segmentation, where the format is open response (2 scaffolded, 5 independent including 2 words with initial consonant blends). The practice items include two practice items with corrective feedback, with an item total of five. A scaffolded example may be “what are the three sounds in bed?”

FIG. 10 is an example question with writing for sounds for the system and method of FIG. 1 consistent with the present disclosure. An independent example may be “what are the sounds in fish?”

FIG. 11 is another example question with writing for sounds for the system and method of FIG. 1 consistent with the present disclosure. The example of FIG. 11 includes writing for sounds, where the format is open response [single image presented to reduce memory demands]. The practice items include two practice items with corrective feedback, with an item total of five. An example may be “write the sounds you hear in cart?”

At conclusion, the disclosed app generates a vocabulary score (at target, below target, above target), and one or more phonological awareness scores (total score, by subtest).

The app screen and technology are described next. The app is written so that all the assessment screens are on a single load to create a faster speed between requests and minimize calls to the server. As the app is continually being used, all of the data provided by the assessments, the app may learn and adjust by use of key algorithms (the beginning of an AI development), making each future assessment better.

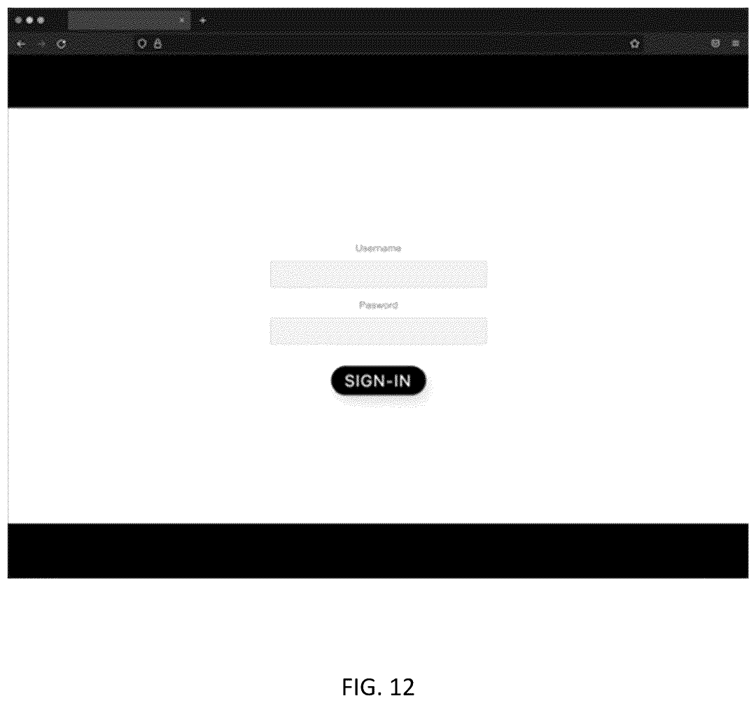

FIG. 12 is an example of a secure login screen for the Graphical User Interface (GUI) of one illustrative embodiment of the system and method of FIG. 1. The app may start with a required secure login as shown in FIG. 12. The login credentials may be created by the license's administrator in the secure admin zone of the app.

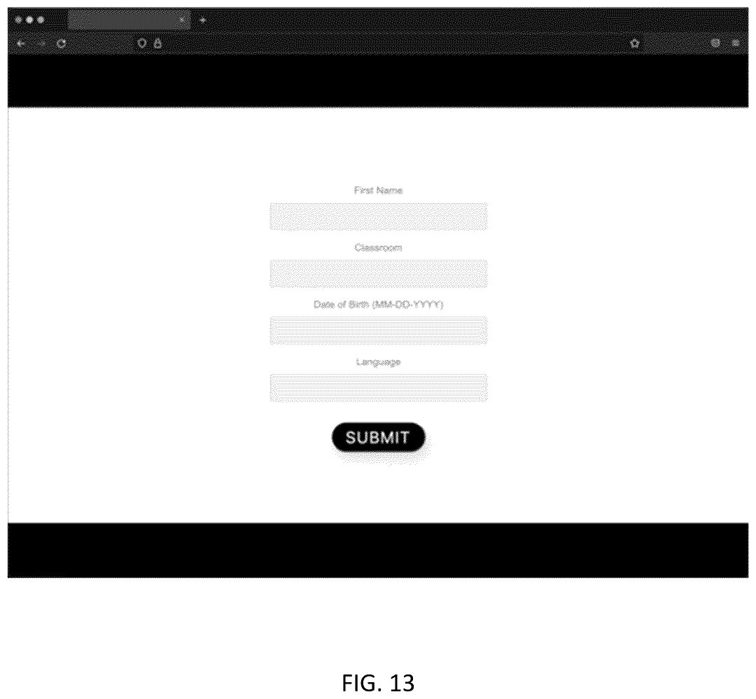

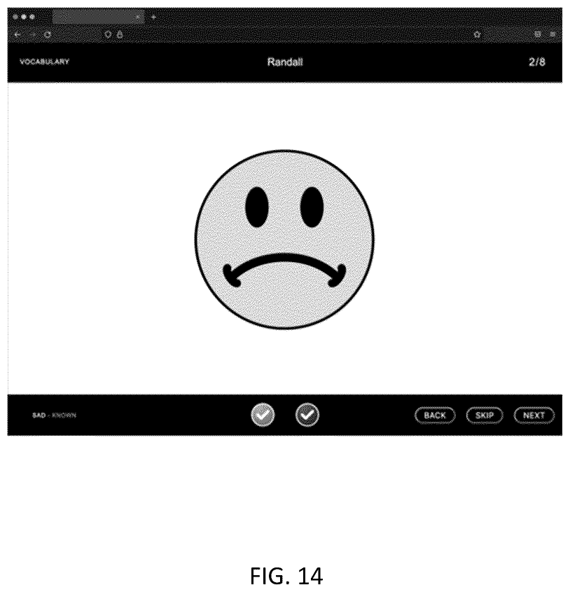

FIG. 13 is an example of a subject data entry screen for the GUI of an embodiment of the system and method of FIG. 1. Once logged in, the assessor clicks the Start button and then selects the child from a list of previously completed assessments or enters the child's details, such as name, age, classroom, and preferred language, as shown in FIG. 13. Upon clicking Submit, the assessor is taking to the Vocabulary assessment, FIG. 14.

FIG. 14 is an example of a vocabulary assessment screen for the GUI of an embodiment of the system and method of FIG. 1. Here the assessor is looking to create a collection of known and unknown words specific to this child for use in the future assessments. The disclosed app may base the selection of images and words the child is shown based upon their age and standard levels of assessment, per the AoA word ratings, among others. If during the first stage of vocabulary the app algorithm finds the child has a difficult time with the selected level, the app will begin to show younger AoA words lower it until it finds the proper level and the child builds a bank of know words. This is also true going the other direction if the child has an easier time with the initial AoA selection, the app may raise the age level until a balance of known and unknown words is identified.

During this stage, the child is presented with a picture and the word the assessor is hoping to identify is in the lower left with its proposed status. The assessor may ask “can you name this picture?” or “what is this?” to have the child answer. The child's name appears along the top, along with the number count of words. On the bottom right are a series of buttons to allow the assessor to move freely within the app. Centered below the image may be a means for the assessor to record whether the child define the image using the target word. When this assessment is complete, the screen may display a message for the assessor to move to the next assessment, and the assessor may click Next to begin the next assessment tool.

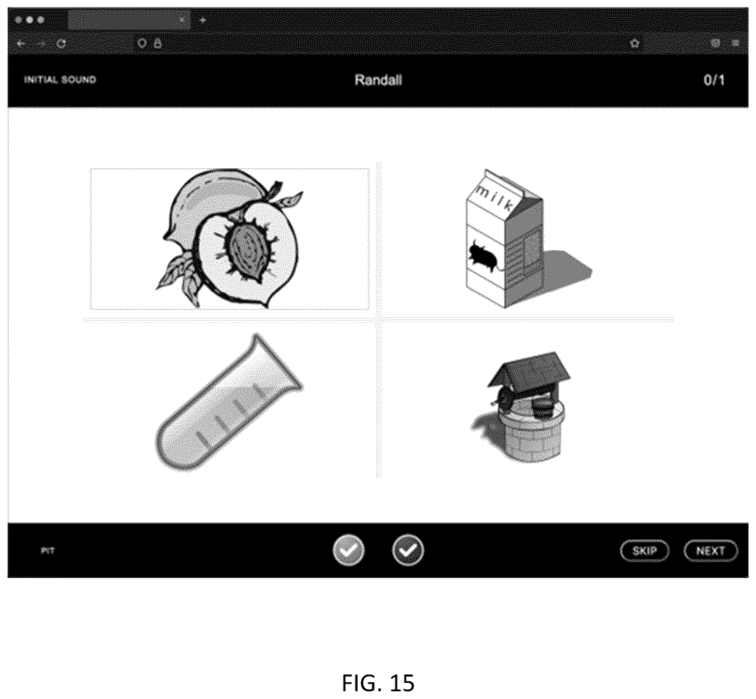

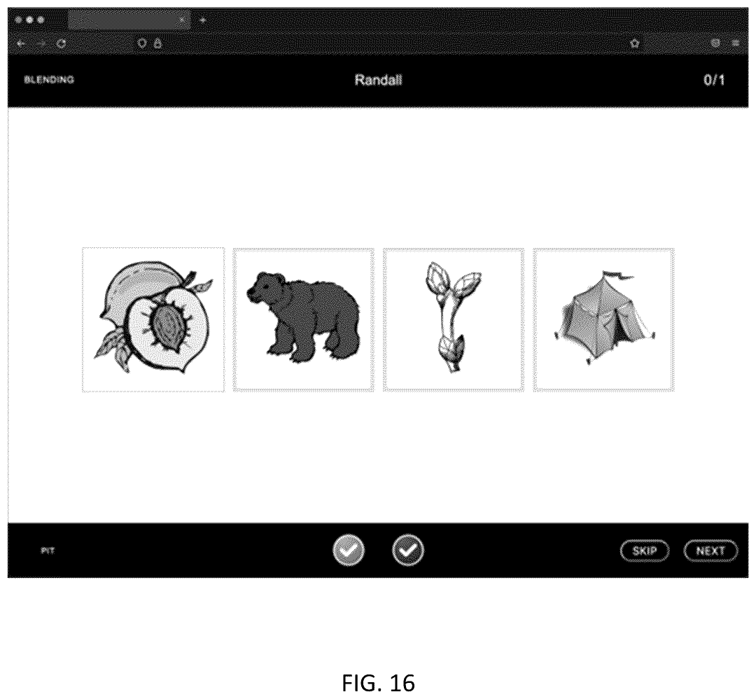

FIG. 15 and FIG. 16 are examples of multiple image assessment screens for the GUI of an embodiment of the system and method of FIG. 1. For those assessments that show multiple images, e.g., FIGS. 15 & 16, the child may identify which image match the style of the assessment as spoken by the assessor. The image chosen by the child is then highlighted. The assessor uses the centered objects below the pictures to record if the child had the response correct, or they may use the buttons on the right to freely move with the assessment.

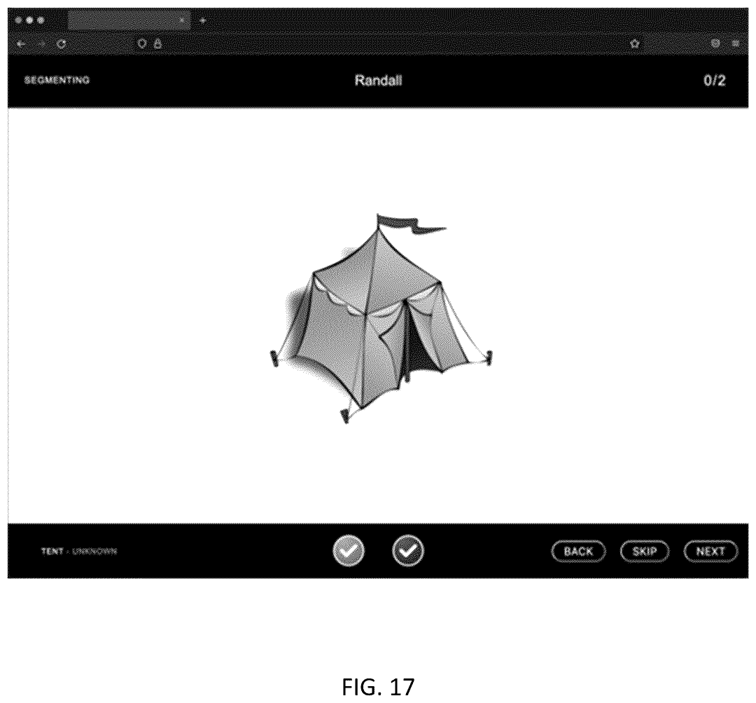

FIG. 17 is an example of a single image assessment screen for the GUI of an embodiment of the system and method of FIG. 1 consistent with the present disclosure. This style of assessment may show a single image and provide the assessor the type of assessment to ask the child. Can the child understand the syllable segmentation, multisyllabic words, etc.? For those assessments that show single images, e.g., FIG. 17, the child may identify the image match the verbal style of the assessment as spoken by the assessor. The assessor uses the centered objects below the pictures to record if the child had the response correct, or they may use the buttons on the right to freely move with the assessment. Once the assessor has run through all the assessment stages, or if they clicked next to skip a stage, they may be presented with the final, “The End” page.

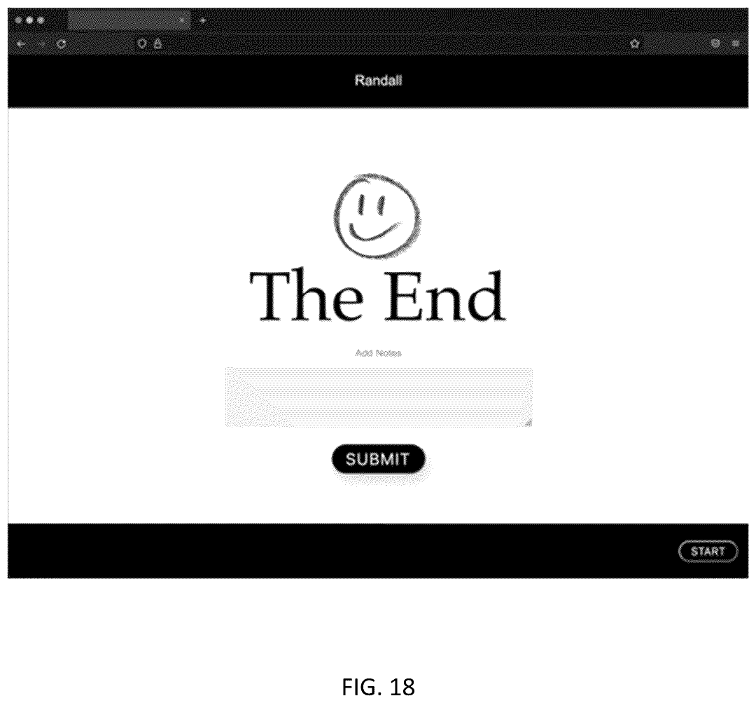

FIG. 18 is an example of a completion screen for the GUI of an embodiment of the system and method of FIG. 1. On this page, the assessor may add any notes to be entered into the child's record by clicking the Submit icon, or if no notes are needed, they may click the Start link to begin a new assessment, with the selecting an existing child or entering of another child's details.

Upon completing the assessment of a child, a classroom or other group, an approved admin user may log into the secure admin area to retrieve and generate reports. These reports may provide insight as to the target level of their vocabulary. The reports may provide a score by task and a total score on the phonological awareness of the individual or the group.

The generated reports are for the school as general trends in the classroom, disaggregated data for use in federal and state reporting, and classroom reports and individual student scores. The report may also provide teachers and school officials individualized teaching materials for the whole group, small group, and individualized instructional materials for comprehensive early literacy instruction. These reports may also be able to track the history of the child or classroom over the course of their young education.

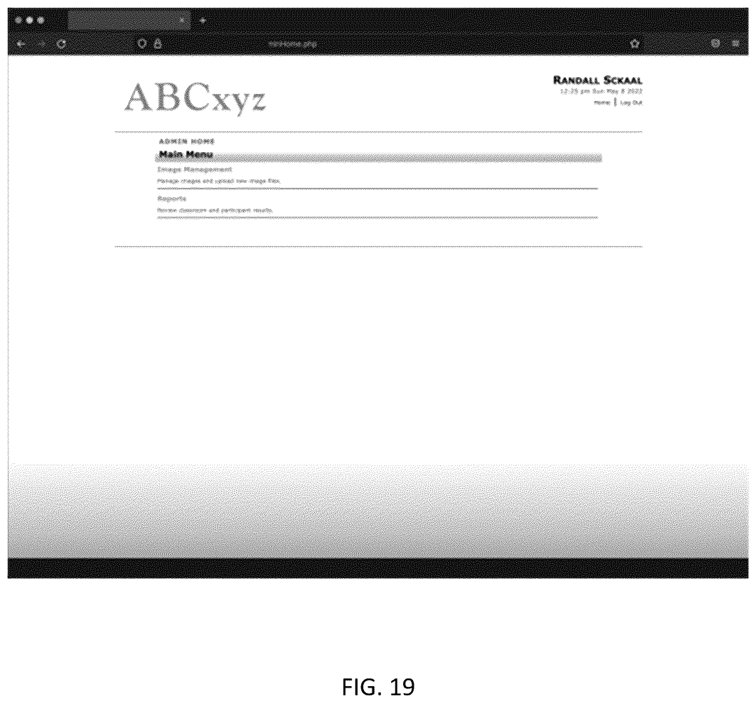

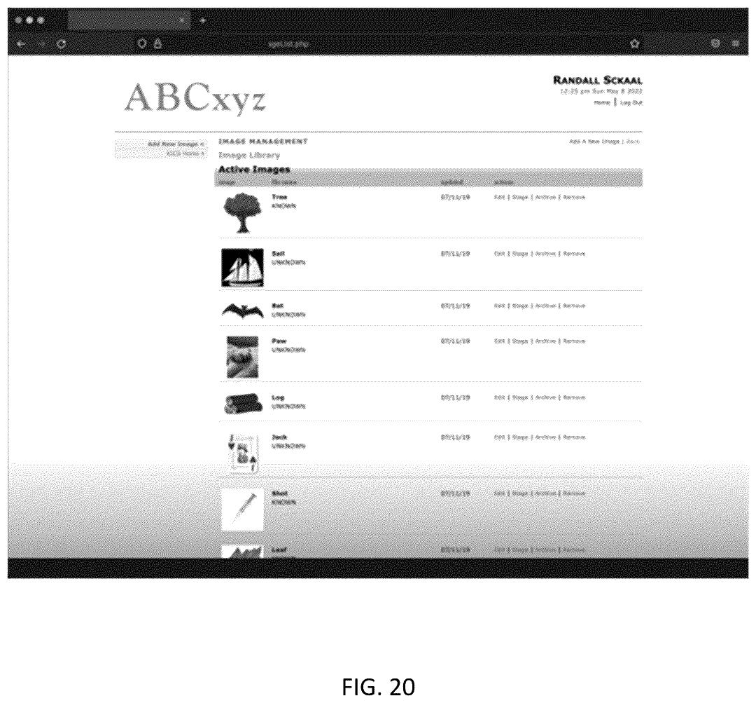

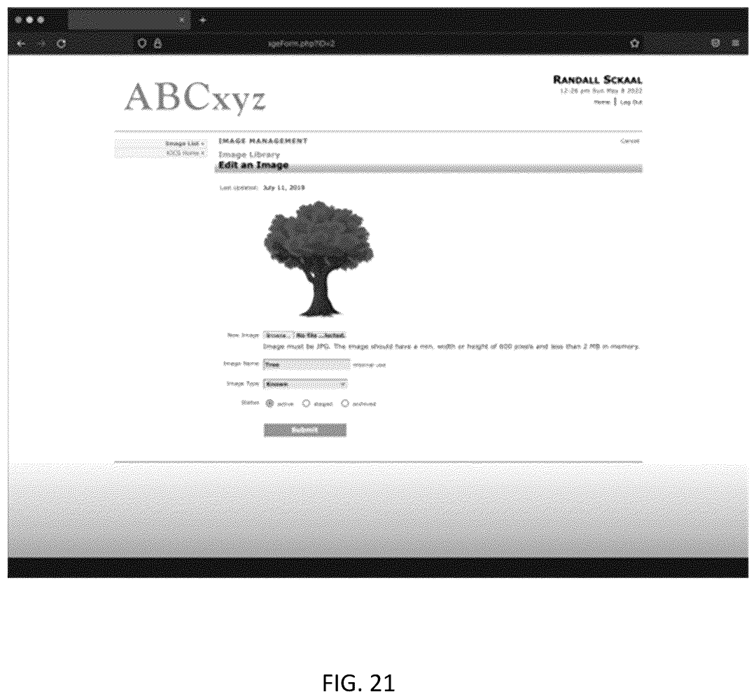

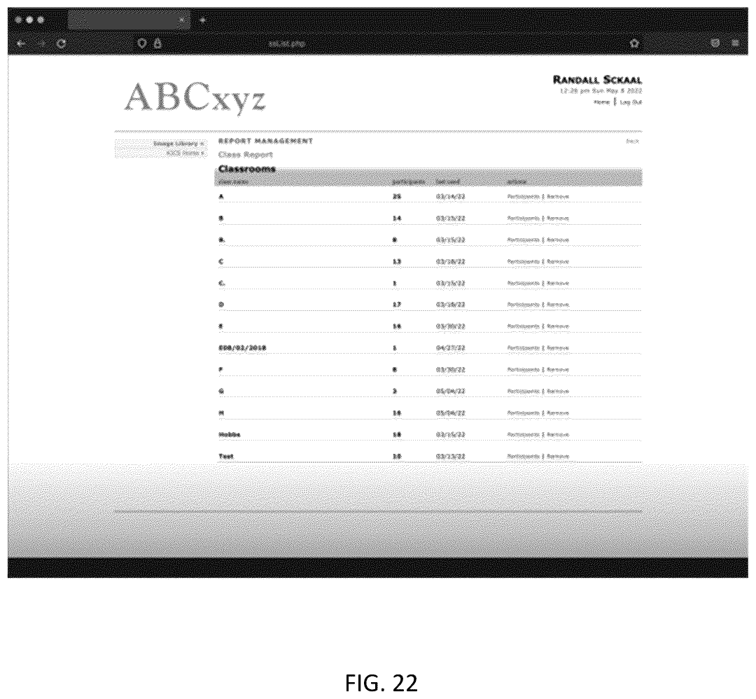

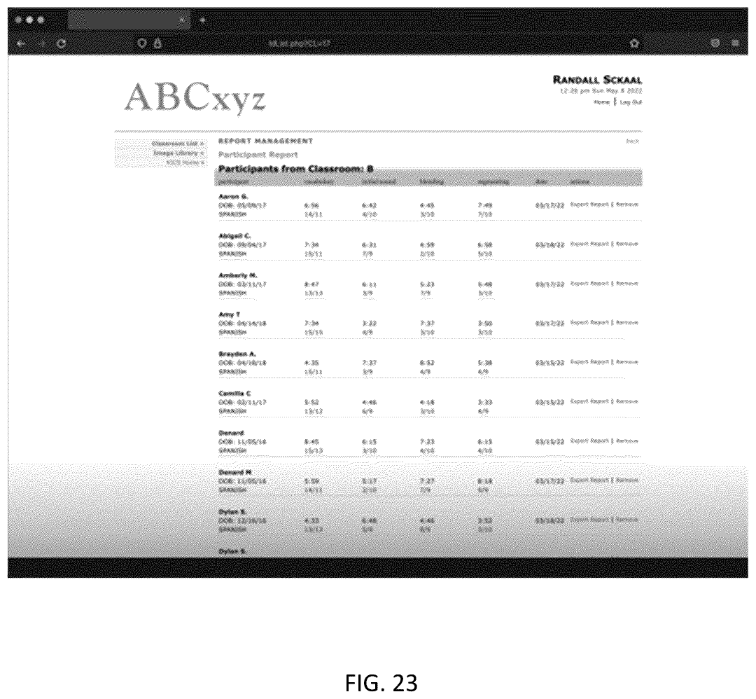

FIGS. 19-23 illustrate the example screens for navigating the reports and management.

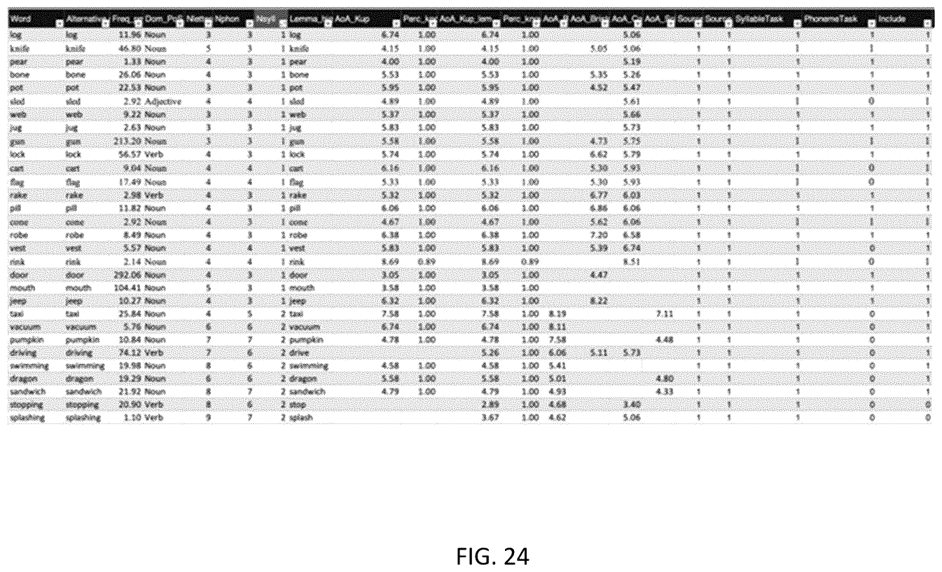

FIG. 24 is an example of an application database of word examples for the system and method of FIG. 1 consistent with the present disclosure.

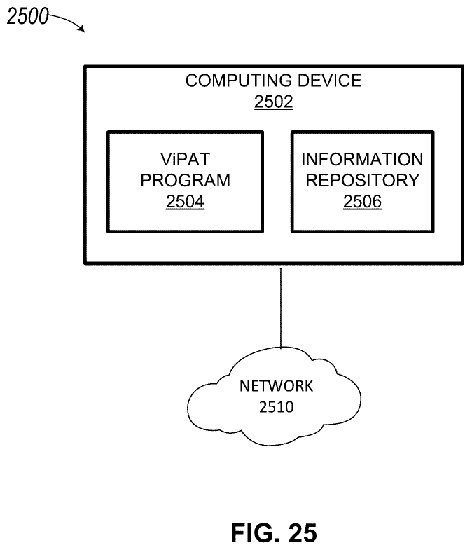

FIG. 25 is a functional block diagram illustrating a distributed data processing environment, generally designated 2500, suitable for operation of the ViPAT program 2504 in accordance with at least one embodiment of the present disclosure. The term “distributed” as used herein describes a computer system that includes multiple, physically distinct devices that operate together as a single computer system. FIG. 25 provides only an illustration of one implementation and does not imply any limitations with regard to the environments in which different embodiments may be implemented. Many modifications to the depicted environment may be made by those skilled in the art without departing from the scope of the disclosure as recited by the claims.

Distributed data processing environment 2500 includes computing device 2502 optionally connected to network 2510. Network 2510 can be, for example, a telecommunications network, a local area network (LAN), a wide area network (WAN), such as the Internet, or a combination of the three, and can include wired, wireless, or fiber optic connections. Network 2510 can include one or more wired and/or wireless networks that are capable of receiving and transmitting data, voice, and/or video signals, including multimedia signals that include voice, data, and video information. In general, network 2510 can be any combination of connections and protocols that may support communications between computing device 2502 and other computing devices (not shown) within distributed data processing environment 2500.

Computing device 2502 can be a standalone computing device, a management server, a web server, a mobile computing device, or any other electronic device or computing system capable of receiving, sending, and processing data. In an embodiment, computing device 2502 can be a laptop computer, a tablet computer, a netbook computer, a personal computer (PC), a desktop computer, a smart phone, or any programmable electronic device capable of communicating with other computing devices (not shown) within distributed data processing environment 2500 via network 2510. In another embodiment, computing device 2502 can represent a server computing system utilizing multiple computers as a server system, such as in a cloud computing environment. In yet another embodiment, computing device 2502 represents a computing system utilizing clustered computers and components (e.g., database server computers, application server computers) that act as a single pool of seamless resources when accessed within distributed data processing environment 2500.

In an embodiment, computing device 2502 includes the ViPAT program 2504. In an embodiment, the ViPAT program 2504 is a program, application, or subprogram of a larger program assessment of phonological awareness. In an alternative embodiment, the ViPAT program 2504 may be located on any other device accessible by computing device 2502 via network 2510.

In an embodiment, computing device 2502 includes information repository 2506. In an embodiment, information repository 2506 may be managed by the ViPAT program 2504. In an alternate embodiment, information repository 2506 may be managed by the operating system of the computing device 2502, alone, or together with, the ViPAT program 2504. Information repository 2506 is a data repository that can store, gather, compare, and/or combine information. In some embodiments, information repository 2506 is located externally to computing device 2502 and accessed through a communication network, such as network 2510. In some embodiments, information repository 2506 is stored on computing device 2502. In some embodiments, information repository 2506 may reside on another computing device (not shown), provided that information repository 2506 is accessible by computing device 2502. Information repository 2506 includes, but is not limited to, satellite data, spectrogram data, RF data, orbital path data, orbital element data, waterfall data, and other data that is received by the ViPAT program 2504 from one or more sources, and data that is created by the ViPAT program 2504.

Information repository 2506 may be implemented using any non-transitory volatile or non-volatile storage media for storing information, as is known in the art. For example, information repository 2506 may be implemented with random-access memory (RAM), solid-state drives (SSD), one or more independent hard disk drives, multiple hard disk drives in a redundant array of independent disks (RAID), optical library, or a tape library. Similarly, information repository 2506 may be implemented with any suitable storage architecture known in the art, such as a relational database, an object-oriented database, or one or more tables.

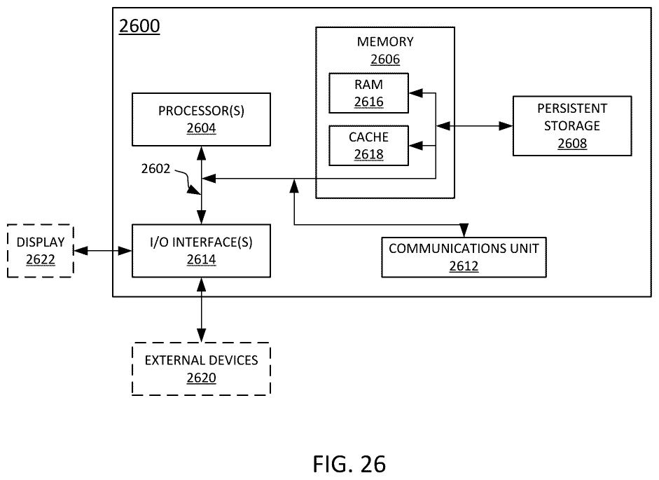

FIG. 26 is a block diagram depicting components of one example of the computing device 2500 suitable for the ViPAT program 2504, within the distributed data processing environment of FIG. 25, consistent with the present disclosure. FIG. 26 displays the computing device or computer 2600, one or more processor(s) 2604 (including one or more computer processors), a communications fabric 2602, a memory 2606 including, a random-access memory (RAM) 2616 and a cache 2618, a persistent storage 2608, a communications unit 2612, I/O interfaces 2614, a display 2622, and external devices 2620. It should be appreciated that FIG. 26 provides only an illustration of one embodiment and does not imply any limitations with regard to the environments in which different embodiments may be implemented. Many modifications to the depicted environment may be made.

As depicted, the computer 2600 operates over the communications fabric 2602, which provides communications between the computer processor(s) 2604, memory 2606, persistent storage 2608, communications unit 2612, and input/output (I/O) interface(s) 2614. The communications fabric 2602 may be implemented with an architecture suitable for passing data or control information between the processors 2604 (e.g., microprocessors, communications processors, and network processors), the memory 2606, the external devices 2620, and any other hardware components within a system. For example, the communications fabric 2602 may be implemented with one or more buses.

The memory 2606 and persistent storage 2608 are computer readable storage media. In the depicted embodiment, the memory 2606 comprises a RAM 2616 and a cache 2618. In general, the memory 2606 can include any suitable volatile or non-volatile computer readable storage media. Cache 2618 is a fast memory that enhances the performance of processor(s) 2604 by holding recently accessed data, and near recently accessed data, from RAM 2616.

Program instructions for the ViPAT program 2504 may be stored in the persistent storage 2608, or more generally, any computer readable storage media, for execution by one or more of the respective computer processors 2604 via one or more memories of the memory 2606. The persistent storage 2608 may be a magnetic hard disk drive, a solid-state disk drive, a semiconductor storage device, flash memory, read only memory (ROM), electronically erasable programmable read-only memory (EEPROM), or any other computer readable storage media that is capable of storing program instruction or digital information.

The media used by persistent storage 2608 may also be removable. For example, a removable hard drive may be used for persistent storage 2608. Other examples include optical and magnetic disks, thumb drives, and smart cards that are inserted into a drive for transfer onto another computer readable storage medium that is also part of persistent storage 2608.

The communications unit 2612, in these examples, provides for communications with other data processing systems or devices. In these examples, the communications unit 2612 includes one or more network interface cards. The communications unit 2612 may provide communications through the use of either or both physical and wireless communications links. In the context of some embodiments of the present disclosure, the source of the various input data may be physically remote to the computer 2600 such that the input data may be received, and the output similarly transmitted via the communications unit 2612.

The I/O interface(s) 2614 allows for input and output of data with other devices that may be connected to computer 2600. For example, the I/O interface(s) 2614 may provide a connection to external device(s) 2620 such as a keyboard, a keypad, a touch screen, a microphone, a digital camera, and/or some other suitable input device. External device(s) 2620 can also include portable computer readable storage media such as, for example, thumb drives, portable optical or magnetic disks, and memory cards. Software and data used to practice embodiments of the present disclosure, e.g., the ViPAT program 2504, can be stored on such portable computer readable storage media and can be loaded onto persistent storage 2608 via the I/O interface(s) 2614. I/O interface(s) 2614 also connect to a display 2622.

Display 2622 provides a mechanism to display data to a user and may be, for example, a computer monitor or an interactive whiteboard with projector. Display 2622 can also function as a touchscreen, such as a display of a tablet computer.

According to one aspect of the disclosure, there is thus provided a computer-implemented method for assessment of phonological awareness, the computer-implemented method comprising: displaying, by one or more computer processors, one or more images on a Graphical User Interface (GUI), wherein the one or more images represent one or more words; receiving, by the by one or more computer processors, a response from a subject as to whether the subject knows the specific word for each of the one or more images; responsive to the subject knows the specific word for any of the one or more images, adding, by the by one or more computer processors, the specific word to a list of known words for the subject; displaying, by the by one or more computer processors, one or more known item images on the GUI, wherein the one or more known item images are based on the list of known words for the subject; and determining, by the by one or more computer processors, a picture of phonological awareness that is disentangled from word familiarity based on the one or more known item images.

According to another aspect of the disclosure there is thus provided a system for assessment of phonological awareness, the method comprising: a network; and one or more computing devices, the one or more computing devices configured to: show a test subject images of words; receive a response from the subject as to whether the subject knows the word; and show the test subject items with words known by the subject to provide a picture of PA that is disentangled from word familiarity.

According to yet another aspect of the disclosure, there is thus provided a method for assessment of phonological awareness, the method comprising: showing a test subject images of words; receiving a response from the subject as to whether the subject knows the words; showing the test subject items with words known by the subject to provide a picture of phonological awareness that is disentangled from word familiarity.

As used in this application and in the claims, a list of items joined by the term “and/or” can mean any combination of the listed items. For example, the phrase “A, B and/or C” can mean A; B; C; A and B; A and C; B and C; or A, B and C. As used in this application and in the claims, a list of items joined by the term “at least one of” can mean any combination of the listed terms. For example, the phrases “at least one of A, B or C” can mean A; B; C; A and B; A and C; B and C; or A, B and C.

“Circuitry,” as used in any embodiment herein, may comprise, for example, singly or in any combination, hardwired circuitry, programmable circuitry such as processors comprising one or more individual instruction processing cores, state machine circuitry, and/or firmware that stores instructions executed by programmable circuitry and/or future computing circuitry including, for example, massive parallelism, analog or quantum computing, hardware embodiments of accelerators such as neural net processors and non-silicon implementations of the above. The circuitry may, collectively or individually, be embodied as circuitry that forms part of a larger system, for example, an integrated circuit (IC), system on-chip (SoC), application-specific integrated circuit (ASIC), programmable logic devices (PLD), digital signal processors (DSP), field programmable gate array (FPGA), logic gates, registers, semiconductor device, chips, microchips, chip sets, etc.

The programs described herein are identified based upon the application for which they are implemented in a specific embodiment of the disclosure. However, it should be appreciated that any particular program nomenclature herein is used merely for convenience, and thus the disclosure should not be limited to use solely in any specific application identified and/or implied by such nomenclature.

The present disclosure may be a system, a method, and/or a computer program product. The system or computer program product may include one or more non-transitory computer readable storage media having computer readable program instructions thereon for causing a processor to carry out aspects of the present disclosure.

The one or more non-transitory computer readable storage media can be any tangible device that can retain and store instructions for use by an instruction execution device. The one or more non-transitory computer readable storage media may be, for example, but is not limited to, an electronic storage device, a magnetic storage device, an optical storage device, an electromagnetic storage device, a semiconductor storage device, or any suitable combination of the foregoing. A non-exhaustive list of more specific examples of the one or more non-transitory computer readable storage media includes the following: a portable computer diskette, a hard disk, a RAM, a ROM, an EPROM or Flash memory, a Static Random Access Memory (SRAM), a portable Compact Disc Read-Only Memory (CD-ROM), a Digital Versatile Disk (DVD), a memory stick, a floppy disk, a mechanically encoded device such as punch-cards or raised structures in a groove having instructions recorded thereon, and any suitable combination of the foregoing. A non-transitory computer readable storage media, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from one or more non-transitory computer readable storage media or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in one or more non-transitory computer readable storage media within the respective computing/processing device.

Computer readable program instructions for carrying out operations of the present disclosure may be assembler instructions, Instruction-Set-Architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a LAN or a WAN, or the connection may be made to an external computer (for example, through the Internet using an Internet Service Provider). In some embodiments, electronic circuitry including, for example, programmable logic circuitry, Field-Programmable Gate Arrays (FPGA), or other Programmable Logic Devices (PLD) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It may be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, a special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in one or more non-transitory computer readable storage media that can direct a computer, a programmable data processing apparatus, and/or other devices to function in a particular manner, such that the one or more non-transitory computer readable storage media having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operations to be performed on the computer, other programmable apparatus, or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, a segment, or a portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It may also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present disclosure have been presented for purposes of illustration but are not intended to be exhaustive or limited to the embodiments disclosed. Many modifications and variations may be apparent to those of ordinary skill in the art without departing from the scope and spirit of the disclosure. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A computer-implemented method for assessment of phonological awareness, the computer-implemented method comprising:
displaying, by one or more computer processors, one or more images on a Graphical User Interface (GUI), wherein the one or more images represent one or more words;
receiving, by the by one or more computer processors, a response from a subject as to whether the subject knows the specific word for each of the one or more images;
responsive to the subject knows the specific word for any of the one or more images, adding, by the by one or more computer processors, the specific word to a list of known words for the subject;
displaying, by the by one or more computer processors, one or more known item images on the GUI, wherein the one or more known item images are based on the list of known words for the subject; and
determining, by the by one or more computer processors, a picture of phonological awareness that is disentangled from word familiarity based on the one or more known item images.

2. A system for assessment of phonological awareness, the method comprising:
a network; and
one or more computing devices, the one or more computing devices configured to:
show a test subject images of words;
receive a response from the subject as to whether the subject know the word; and
show the test subject items with words known by the subject to provide a picture of PA that is disentangled from word familiarity.

3. A method for assessment of phonological awareness, the method comprising:
showing a test subject images of words;
receiving a response from the subject as to whether they know the words; and
showing the test subject items with words known by the subject to provide a picture of phonological awareness that is disentangled from word familiarity.
